(19) United States
(12) Patent Application Publication
(10) Pub. No.: US 2012/0141785 A1
(43) Pub. Date: Jun. 7, 2012

(54) Process for application of durable fast drying multi-coat organic coating system

(76) Inventor: Hugh Winters Lowrey, Austell, GA (US)

(21) Appl. No.: 12/799,280

(22) Filed: Apr. 21, 2010

Related U.S. Application Data
(63) Continuation-in-part of application No. 12/008,503, filed on Jan. 11, 2008, now abandoned.

(51) Int. Cl. B32B 15/08; B05D 3/02; B05C 1/04

(52) U.S. Cl. 428/339; 427/136; 427/374.1; 427/138; 427/393

(57) ABSTRACT

Disclosed is a process comprising application of one or more successive hot-melt coatings to solid surfaces of an article or alternatively to a pavement surface, immediately followed by application of a water-thinned coating to the hot-melt coating. Preferred articles are comprised of forest products or ferrous metals and may be for interior or exterior use. This coating system can function as a primer applied at the point of manufacture of the article and intended to receive one or more additional coats of conventional paint. Alternatively, it can function as a finished coating system. Coating systems applied to pavement can be for lane marking. Coatings can be formed that are very durable on difficult forest product surfaces and can be designed to emit virtually no air pollutants and to be free of toxic or flammable solvents.

### CROSS REFERENCE TO RELATED APPLICATION

This application is a continuation-in-part of Ser. No. 12/008,503, filed Jan. 11, 2008 by the present inventor, which is incorporated by reference.

### PROCESS FOR APPLICATION OF DURABLE FAST DRYING MULTI-COAT ORGANIC COATING SYSTEM

### Field

The disclosed matter generally relates to processes for applying protective, decorative, and/or visibility-enhancing coatings to surfaces, including cellulosic surfaces. The disclosed subject matter also relates to coating compositions and to coated articles.

### BACKGROUND

Most coating systems related to this disclosure were composed of materials that were liquid at ambient temperatures prior to their application to a surface. They were applied at the point of manufacture of a cellulosic or metal article to be coated, or to a pavement surface. Application processes included spraying, brushing, curtain coating, roll coating, dipping and flow coating, among others.

Exceptions, which were non-liquid coatings, included hot-melt asphalt or tar coatings for roofs and for some other non-decorative exterior waterproofing. Carroll has disclosed a process (U.S. Pat. No. 2,012,496 (1935) to Carroll) that can be interpreted to involve the application of a coat of bitumen emulsion over a bituminous hot-melt coating. The assumed coating process takes place during the mixing of the coating materials with heated aggregate, for pavement. So the actual coating process and whether the emulsion survives to lay down a coating cannot be observed.

Another such exception was thermoplastic, or hot-melt, pavement marking paint, which was solid at ambient temperatures. It required elevated temperatures to reduce viscosity for application. It was applied by extrusion, screed or hot spray, generally as a single coat system. (cf. U.S. Pat. No. 4,713,404 to Cavitt (1987); U.S. Pat. No. 5,928,716 to Finley (1999); U.S. Pat. No. 6,107,367 to Lazarus et al (2000); U.S. Pat. No. 6,552,110 (2003) to Yalvac; U.S. Pat. No. 6,627,678 (2003) to Delme et al.) Other exceptions were a small number of hot-melt coatings designed for protection of metal. (cf. Patent Application EP539941 A1 (1993) by Edwards et al; U.S. Pat. No. 4,150,192 (1979) to Downey; U.S. Pat. No. 5,455,075 (1995) to Longo; U.S. Pat. No. 5,074,913 (1991) to Trivett. Patent JP08127758A (1994) to Fujitani et al. discloses a thermoplastic pavement marking paint intended to be recoated. Processes involving recoating while the thermoplastic coating is in the molten state are excluded because the intended purpose can only be accomplished by use of a stencil.

The use of hot melt coatings in printing processes, recoated in some instances with water-thinned coatings, is disclosed by Koshizuka and by Gu (U.S. Pat. No. 5,219,610 (1993) to Koshizuka et al, U.S. Pat. No. 6,403,202 B2 (2002) to Gu et al.)

Hot-melt coatings were also used on fabrics and widely used in packaging, mostly on paper or paperboard. (cf. U.S. Pat. No. 4,990,364 (1991) to Bolte et al.; U.S. Pat. No. 7,074,858 (2006) to Heilman et al.) The coatings referenced for metal and packaging were single coat systems. Two-coat systems were even fewer. U.S. Pat. No. 3,970,771 (1976) to Davison discloses a primer intended primarily for plastic surfaces and intended to be recoated. U.S. Pat. No. 2,838,419 A (1958) to Francis discloses a hot-melt anti-corrosive coating for ship bottoms that also envisioned one or more additional coats. Water-thinned paints are excluded from the possible additional coats because they are not useful under water, and were not in use at all for metal protection when the patent was issued in 1958.

Thus, relevant past practice included a broad spectrum of coating processes, of coatings and of cellulosic, metal, plastic, fabric and pavement surfaces.

Evolution of Volatile Materials from Coatings

Except for the limited number of hot-melt coatings described above, most of the coatings used heretofore on cellulosic, metal and pavement surfaces have employed volatile substances to facilitate application by reducing viscosity. That is, solvents or water were present, requiring evaporation during the process of drying the coating. Evolution of volatiles from coating films creates microscopic channels that remain permanently in the dried coating film. Passages are thereby opened for entry of agents harmful to the substrate and the coating. Harmful agents include water and corrosives, dissolved colored matter that causes unsightly stains in the film, and undesirable biological organisms such as mildew.

In addition, the presence of volatiles detracts from coating performance at high film thickness because some volatiles remain in the film, altering its composition in undesirable ways. This effectively limits the protection afforded by the coating, by limiting the thickness at which it will perform optimally.

Another serious problem with the evaporation of volatile substances is that they themselves, with few exceptions other than water, are considered to be air pollutants. In practice, even coatings thinned with water usually contain significant quantities of polluting organic solvents. A rare exception to this may occur when a coating based on a latex emulsion can be cured by heat, which avoids the need for solvents to aid in coalescence of the latex particles. Environmental legislation and government regulations now restrict solvent emissions, requiring compromises in the formulation of coatings that often lead to diminished performance. Recycling of organic volatiles by industrial emitters is a common alternative. However, recycling treatment processes are technically and economically quite burdensome and almost never 100 percent effective.

### Hot-Melt Coatings as an Alternative

Hot-melt coatings would offer a way to curtail air pollution by evaporation of solvents, if they could be used on surfaces such as siding for structures. But obstacles to their use have been the technical and economic difficulties of simultaneously overcoming their tendency to block, or cause coated articles to stick together when stacked, and their limited exterior durability. The types of equipment required for application of hot-melt coatings, other than asphalt or tar coatings and pavement markings, almost always necessitate that they be applied at the point of manufacture of the article to be coated. It follows that packaging or palletizing and shipping of coated articles are essential steps in bringing them to market. This necessitates good block resistance under a variety of conditions. The solutions to this problem employed to date have generally involved chemical cross-linking of hot-melt coatings. This can overcome their thermoplasticity and provide hard and block resistant films at all relevant temperatures. Means of accomplishing this within the very short time frame afforded on an industrial finishing line have included electron or ultra-violet light beams, along with coatings designed to form cross-links when exposed to such energy beams. These methods limit pigmentation of the coating, and film thickness, and can complicate the development of adhesion by subsequent coatings. Another approach is to apply heat to cross-link the hot-melt coating film, but acceptable temperatures and times of exposure to heat are limited when the coated substrate is heat-sensitive.

With the exception of asphalt and tar coatings and thermoplastic road markings, the preponderance of usage of hot-melt compounds has been for adhesives. As stated, other areas of use of hot-melt coatings have been for printing and on fabrics and packaging. Aside from asphalt and tar coatings there is little or no record of usage of hot-melt coatings for protection of surfaces from the weather.

### Past Experience in the Use of Organic Coatings Applied at the Point of Manufacture to Protect and Decorate Materials Based on Forest Products and Intended for Exterior Use

Wood and manufactured materials made from wood laminates, fibers, strands, chips and the like are often used for structural components intended for exposure to weather. Such uses subject the cellulosic surface to deterioration by the ultra-violet component of sunlight. Within weeks or even days of exposure the unprotected surface can be seriously weakened. This compromises the adhesion of the architectural paints customarily applied during later stages of construction. The universal remedy for this problem has been the application of protective coatings or laminates at the point of manufacture. The object has been to prevent the deterioration of the exposed surface and preserve its recoatability. This approach has been applied in different ways to different forest product surfaces, with varied degrees of success.

During the 1960s, paint primers were applied to wood siding at the point of manufacture in an attempt to improve the durability of architectural paint systems used on it. The effort failed and wood siding lost most of its market. More recently, where wood surfaces have been exposed to weather in structural applications, most efforts to prevent surface degradation have been abandoned. Instead, film-forming coatings have been avoided where possible. Pigmented stains, providing less protection, have been used instead, to minimize later failure by flaking.

For the past few decades, almost all hardboard intended for exterior use on structures has been primed with one or another opaque water-thinned organic coating at the point of manufacture. Hardboard manufacturers have generally recommended that a coat of a more durable primer be applied over the shop primer, within 30 days of installation. It has often been difficult to comply with these recommendations in scheduling construction, but failure to comply has its consequences. It has not infrequently lead to sub-standard performance of the architectural coating system used on the structure. Hardboard siding has been subject to bleed of waxes used in its manufacture, disfiguring the surface after application of finish paints. An even more intractable problem has been “edge swelling.” This refers to swelling by moisture absorption near hardboard panel edges, with possible consequential disintegration of the siding. Primers heretofore applied at the point of manufacture have not been successful in preventing these modes of failure in susceptible lots of siding.

When plywood is exposed to weather, cracks open in the outer veneer, parallel to the wood grain. Also weather exposure roughens the plywood surface because woods of varying density, such as springwood and summerwood in the outer veneer, expand to different degrees when they absorb moisture. Organic coatings have not successfully overcome these failings. No commercial primer applied at the point of manufacture has been successfully used on non-overlaid plywood. As with wood siding, pigmented stains have generally been applied to structural plywood exposed to weather. This is in preference to coatings that could offer better protection if they did not have a history, on plywood, of premature failure by flaking. Smooth sanded plywood has not generally been considered satisfactory for outdoor use. Rather, grades with rough surfaces such as “rough sawn” plywood have been used to minimize the impact of problems expected to develop. The lamination of resin-impregnated Kraft paper (“overlay”) to plywood surfaces has provided an excellent surface for durable paint, but the expense of this approach has severely limited its market.

Oriented strand board, or OSB, a more economical material with many properties competitive to plywood, has been widely used in construction. However, its susceptibility to swelling and disintegration by absorption of moisture has made it hard to protect during extended exterior exposure. Consequently it has met with greater success where exposure was temporary, such as in sheathing and roof decks. Protection by organic coatings, in these applications, needed to be only for periods of months at the most. Specially designed OSB with more durable factory-applied primer has been used on permanently exposed structural members, but no consensus has formed on its long-term durability.

The OSB product that was originally marketed for siding and other exposed surfaces encountered serious problems in some climates. Moisture condensed in the walls of structures on which it was used, causing rot and growth of toxic mold. This apparently occurred when the moisture permeability of the coated OSB was inadequate to permit the escape of moisture from the humid indoor atmosphere that occupants of a structure tend to create. Humidity built up in the walls behind the siding and when the temperature fell below the dew point, the condensation that resulted fostered decay and mold growth.

Past Experience in Shop Priming Ferrous Metals to Protect them from Corrosion

Steel and other ferrous metals have frequently been shop primed, or primed at the point of manufacture, with an organic coating as a first step in protecting them against atmospheric corrosion, and against splashing and other temporary exposure to corrosive water-borne chemicals. Conventional shop priming has been subject to the limitations described above that affect any coating with volatile ingredients. Furthermore, the primers used have sometimes been slow to dry. And formulation to reduce air pollution, required by government rules, has made effective corrosion protection more difficult to achieve. Beyond that, when there has been a need to form the steel after painting, it has often limited the primers to very thin films with consequent diminution of protective properties.

### Past Experience in the Use of Organic Coatings Applied at the Point of Manufacture to Protect and Decorate Interior Paneling and Other Interior Decorative Surfaces

Most coating systems intended for interior paneling and similar surfaces are translucent or transparent to display natural or simulated wood grain, and are multicoat systems. A seal coat is applied either directly to the uncoated surface or over a non-protective stain. Additional coats are then applied to provide the appearance and protective properties desired.

Historically, nitrocellulose lacquers were used for this purpose. Environmental regulations now make it necessary to use other types of coatings, with water-thinned coatings often preferred. However, when the seal coat is water-thinned, the bleeding of wood stains and roughening of the surface by non-uniform swelling of wood fibers (“grain raising”) become serious problems. Consequently, a non-aqueous seal coat polymerized by a beam of ultra-violet radiation (“UV coating”) is often used. Water-thinned coatings can then be employed for the coats applied over the seal coat.

There are several limitations and problems with systems of this type. Opaque pigmentation can interfere with the cure of UV coatings. Also, when the surface is a porous material such as wood, the energy beam may not cure coating material that penetrates the surface, and uncured monomers present in the UV coating are often toxic. Similarly, these monomers present a hazard to personnel during coating application. Another problem is the frequent difficulty of adhering water-thinned coatings to the highly polymerized surface of the UV seal coat. (cf. Patent application US 20040110020 A1 by Kjellqvist et al.; Patent EP849004B1 (2006) to Lauer et al.)

### Past Experience in Marking Pavement

Thorough preparation of the surface is impractical prior to application of pavement markings. This situation challenges the consistent development of good adhesion to the pavement surface by coatings used as markings. Pavement marking paints thinned to application viscosity with volatile organic solvents had a reasonably good record of meeting this challenge. For several decades they were usually preferred for road lane marking and similar purposes. Environmental regulations now limit their use, and water-thinned paints have often been substituted for them in recent years. These water-thinned markings have been found to exhibit several problems of which limited adhesion to a poorly prepared surface is one.

Thermoplastic, or hot-melt pavement marking materials, when used on roads, have been designed and applied in such a way as to adhere well. Also, they have been capable of application in thick films that increased marking stripe visibility on rainy nights. Reflective glass beads dropped onto them during application, to provide retroreflection of headlights, were thus raised above the level of water on the road. But weather and abrasion eroded thermoplastic marking materials rapidly so that they tended to release the beads prematurely. Thus, a long-lived road stripe has not always meant long lasting night visibility.

In light of the shortcomings of current coating methods and compositions, as described herein, there are unmet needs in that field. There is a need for improved coating compositions, for improved processes for applying protective and decorative coatings to cellulosic and metal surfaces, and similarly for visibility-enhancing coatings on paved surfaces. The compositions and methods disclosed herein address these needs.

### SUMMARY

In accordance with the purposes of the disclosed materials, compounds, compositions, and methods, as embodied and broadly described herein, the disclosed matter, in one aspect, relates to compositions and methods for preparing and using such compositions. In another aspect, disclosed herein are coating compositions and methods for using such compositions to protect, decorate, and/or enhance a surface. Surfaces coated by the disclosed compositions and processes are also disclosed. In a further aspect, disclosed are processes that comprise the application of one or more hot-melt organic coatings to solid surfaces of an article, immediately followed by the application of a water-thinned organic coating to the surface of the hot-melt coating. Articles prepared by the processes disclosed herein are also disclosed. This coating system can function as a primer applied at the point of manufacture of the article and intended to receive one or more additional coats of conventional paint. Alternatively, it can function as a finished coating system.

The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

FIG. 1 is a flow-chart that illustrates a process in which the disclosed coating system is a two-coat system that includes a hot-melt coating formed by mixing two separately manufactured components and is applied to wood or a material made from wood; in which the water-thinned coating is applied to the hot-melt coating while the latter is in a molten state, the water-thinned coating is dried by application of heat, and chemical cross-links form in both the hot-melt and the water-thinned coating.

FIG. 2 is a flow-chart that illustrates a process in which the disclosed coating system is a two-coat system applied to wood or a material made from wood, the water-thinned coating is applied to the hot-melt coating while the latter is in a molten state and the water-thinned coating is dried by application of heat.

FIG. 3 is a flow-chart that illustrates a process in which the disclosed coating system is a two-coat system applied to wood or a material made from wood, the water-thinned coating is applied to the hot-melt coating while the latter is in a molten state and the water-thinned coating is air-dried without external heat.

FIG. 4 is a flow-chart that illustrates a process in which the disclosed coating system is a two-coat system applied to wood or a material made from wood, the water-thinned coating is applied to the hot-melt coating while the latter is in a molten state, the water-thinned coating is dried by application of heat and chemical cross-links form in the water-thinned coating.

FIG. 5 is a flow-chart that illustrates a process in which the disclosed coating system is a three-coat system applied to wood or a material made from wood, a first hot-melt coating is formed by mixing two separately manufactured components, a second hot-melt coating is applied to the first hot-melt coating while the latter is in a molten state, the water-thinned coating is applied to the second hot-melt coating while the latter is in a molten state, the water-thinned coating is dried by application of heat and chemical cross-links form in the first hot-melt coating.

FIG. 6 is a flow-chart that illustrates a process in which the disclosed coating system is a two-coat system applied to wood or a material made from wood, the water-thinned coating is applied to the hot-melt coating while the latter is in a solid state and the water-thinned coating is dried by application of heat.

FIG. 7 is a flow-chart that illustrates a process in which the disclosed coating system is a two-coat system applied to a ferrous metal article, the water-thinned coating is applied to the hot-melt coating while the latter is in a molten state and the water-thinned coating is dried by application of heat.

FIG. 8 is a flow-chart that illustrates a process in which the disclosed coating system is a two-coat system applied to pavement as a stripe, the water-thinned coating is applied to the hot-melt coating as a stripe while the latter is in a molten state and the water-thinned coating is air-dried without external heat.

FIG. 9 is a flow-chart that illustrates a process in which the disclosed coating system is a two-coat system with the hot-melt coating applied as a seal coat to a decorative interior article made of wood or a material made from wood, the water-thinned coating is a first intermediate coat in a multi-coat system and is applied to the hot-melt coating while the latter is in a molten state and the water-thinned coating is dried by application of heat.

### DETAILED DESCRIPTION

The materials, compositions, articles, devices, and methods described herein may be understood more readily by reference to the following detailed description of specific aspects of the disclosed subject matter and methods, and the Examples included therein.

Before the present materials, compositions, articles, devices, and methods are disclosed and described, it is to be understood that the aspects described below are not limited to specific methods or specific reagents or ingredients, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed subject matter pertains. The references disclosed are also individually and specifically incorporated by reference herein for the material contained in them that is discussed in the sentence in which the reference is relied upon.

Further, throughout this specification, application of a water-thinned coating as a protective layer over a hot-melt coating is described as essential to the practice of this invention. The choice of water-thinned coatings for this purpose is dictated first and foremost by the fact that water-thinned coatings belong to the category of coatings that will not, when applied directly over hot-melt coatings as disclosed herein, attack, dissolve, swell, soften or weaken the hot-melt coating film. Other coatings that are potentially in the category suitable for use in recoating these hot-melt films are powder coatings. Also in this category, for some hot-melt coatings under some circumstances, are coatings in which the sole solvent has very limited solvency for the hot-melt films employed, such as those thinned with certain volatile alcohols. Most coatings that utilize solvents to reduce coating viscosity and thereby facilitate application of the coating to a surface, will, if applied directly to most of the hot-melt coatings employed in the practice of this invention, readily attack those films. Hence, they are not considered suitable for use as a coating to be applied, in the practice of this invention, directly to a hot-melt coating surface. However, many coatings thinned with volatile solvents are suitable for use as part of a coating system that includes the disclosed multi-coat system together with additional coatings such as finish coats. Such solvent-thinned coatings can be applied to the multi-coat systems disclosed herein, after the application of a water-thinned coating over a hot-melt coating and the subsequent solidification, drying or curing of the disclosed multi-coat system.

Still further, throughout this specification and in the practice of the disclosed invention, a preferred process consists of the application of a water-thinned coating to the surface of a hot-melt coating while that surface is hot and still molten. This relates to the improved ability of a liquid coating to wet a surface, spread over it, and adhere to it, when interfacial tension is low. The hot-melt surface is a plastic surface, and many plastics are difficult for coatings to wet because of high interfacial tension. The interface between the two coatings is subject to the general rule that interfacial tension usually decreases with increasing temperature. So, while both the hot-melt coatings and the water-thinned coatings disclosed herein are formulated to minimize interfacial tensions, it is of equal importance that the surface of the hot-melt coating is hot and in the molten state when the water-thinned coating is applied. The minimum temperature required to maintain the molten state can vary widely with the compositions of particular hot-melt coatings, but a surface temperature of at least 90° C. will provide assurance of significant reduction in interfacial tension.

The importance of applying coatings to plastics under conditions of minimum interfacial tension is emphasized by references that document the difficulty of firmly adhering paint to many of them. U.S. Pat. No. 6,310,134 (2001) to Templeton et al discloses that it is difficult to achieve adhesion of common conventional coatings to the surface of copolymers of ethylene. Copolymers of ethylene are major components of the hot-melt coating in the Examples in this specification. Other references attest to the common need to chemically or physically modify plastic surfaces to render them coatable, or to use a special primer. Reference is made to corona treatment (cf. for example F. Lawson, Rubber Chem. and Technol., 60:102, 1987) and to plasma treatment (cf. for example L. H. Coopes et al., J. Macromol. Sci.-Chem., 17:217-226, 1982). U.S. Pat. No. 3,970,771, previously referred to, discloses the use of a special primer coating that adheres to low energy hydrocarbon plastic surfaces and to which conventional coatings can then be successfully adhered. Application of this primer from a hot-melt, while not preferred, is described. The usefulness of the primer depends on incorporation of selectively hydrogenated block copolymers at a minimum level of about 25% by weight of total polymer and of resins compatible with non-elastomeric polymer blocks therein. The patent discloses recoating the primer with various conventional paints, with this paint application limited to solidified primer and not to molten hot-melt coating.

Another advantage of the application of the water-thinned coating while the hot-melt is in a molten state concerns minimization of the time required to apply and solidify the two-coat system. The shorter this time, the shorter the length of the industrial coating line and the lower the cost of the process. The heat released during solidification of the hot-melt coating by cooling can hasten the drying of the water-thinned coating by evaporation of volatiles. Likewise, the absorption of heat by evaporation of water from the water-thinned coating can cool the hot-melt coating and accelerate the process of hardening it.

Still further, throughout this specification, application of continuous coating films are described as essential to the practice of this invention. This applies to the application of protective and/or protective and decorative coating systems to various surfaces and application of continuous or interrupted marking stripes to pavement. This specification assumes that printing processes, whether or not they apply continuous films, do not apply protective coatings and are not suitable for pavement marking. Therefore, printing processes, ink and coating materials employed in printing processes, including thermal transfer recording media and including recording media for the ink jet printing method, are excluded from the group of coating processes and coatings disclosed in this specification or employed in the practice of the invention disclosed herein. Similarly, printed surfaces are excluded from the group of coated surfaces disclosed herein or employed in the invention.

Still further, throughout this specification, desired ranges are specified for the thickness of films of coatings that comprise the multi-coat organic protective coating systems described herein. Considerations that can determine the thickness specified for each hot-melt coating described as useful for a particular purpose include, among others, at least some of the following: the required degree of surface protection; the nature of the destructive influences against which the surface must be protected; the length of time protection will be needed; the nature of the protected surface including the monetary value of its protection; the capabilities of the device used for coating application, rheology of the coating; temperature limitations of the stability of the coating; the degree of desired alteration, after coating, of the shape of the object to be coated; the cost, opacity, durability and protective capacity of the specified coating at its specified thickness. The desired ranges of thickness of the water-thinned coating can be determined by the same considerations to the extent that they apply, and also, as further detailed below, can be influenced by the evaporative cooling capacity of the water contained in a coating of the specified thickness. Where very high coating film thickness is necessary and economically feasible to provide the needed degree of surface protection, two advantages of hot-melt coatings, over coatings thinned with volatile substances, have previously been described. First, high thickness does not cause unwanted retention of solvent in the thick hot-melt film and second, hot-melt films have higher integrity due to the absence of microscopic channels that form in coating films as volatile ingredients are released. Continuous films of the hot-melt coatings disclosed herein can under some circumstances be as thick as 1000 micrometers, and films extruded onto small areas can be up to 5000 micrometers (0.5 centimeters). On the other hand, when protective properties are important to the successful performance of any coating, very thin films such as, for example, 5 micrometers, tend to fail regardless of other factors.

### GENERAL DEFINITIONS

In this specification and in the claims that follow, reference will be made to a number of terms, which shall be defined to have the following meanings:

As used in the specification and the appended claims, the singular forms “a,” “an,” and “the” include plural referents unless the context clearly dictates otherwise. Thus, for example, reference to “a coating” includes mixtures of two or more such coatings, reference to “an article” includes mixtures of two or more such articles, reference to “the composition” includes mixtures of two or more such compositions, and the like.

Throughout the specification and claims, the word “comprise” and variations of the word, such as “comprising” and “comprises,” means “including but not limited to,” and is not intended to exclude, for example, other additives, components, integers, or steps.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that is “less than or equal to” the value, then “greater than or equal to the value” and possible ranges between values are also disclosed, as appropriately understood by the skilled artisan. For example, if the value “10” is disclosed then “less than or equal to 10” as well as “greater than or equal to 10” is also disclosed. It is also understood that throughout the application, data are provided in a number of different formats, and that these data represent endpoints and starting points and ranges, for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units is also disclosed. For example, if 10 and 15 are disclosed, then 11, 12, 13, and 14 are also disclosed.

References in the specification and claims, to parts by weight of a particular element or component in a composition or article, denote the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

Disclosed herein are materials, compounds, compositions, and components that can be used for, can be used in conjunction with, can be used in preparation for, or are products of the disclosed methods, devices, and compositions. These and other materials are disclosed herein, and it is understood that when combinations, subsets, interactions, groups, etc. of these materials are disclosed, that while specific reference to each various individual and collective combination and permutation of these compounds may not be explicitly disclosed, each is specifically contemplated and described herein. For example, if a composition is disclosed and a number of modifications that can be made to a number of components or residues of the composition, are discussed, each and every combination and permutation that is possible is specifically contemplated unless specifically indicated to the contrary. Thus, if a class of components or residues A, B, and C are disclosed as well as a class of components or residues D, E, and F, and an example of a combination compound A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to, steps in methods of making and using the disclosed compositions. Thus, if there are a variety of additional steps that can be performed it is understood that each of these additional steps can be performed with any specific aspect or combination of aspects of the disclosed methods, and that each such combination is specifically contemplated and should be considered disclosed.

Certain materials, compounds, compositions, and components disclosed herein can be obtained commercially or readily synthesized using techniques generally known to those of skill in the art. For example, the starting materials and reagents used in preparing the disclosed compounds and compositions are either available from commercial suppliers such as Baker Petrolite Polymers Division (Barnsdall, Okla.), Arkema Incorporated (Philadelphia, Pa.), or Rohm and Haas (Philadelphia, Pa.) subsidiary of Dow Chemical Co. or are prepared by methods known to those skilled in the art following procedures set forth in references such as Macromolecules Volume 1 Chemical Structures and Synthesis (2005) and Volume 2 Industrial Polymers and Synthesis (2007), Hans-Georg, E., John Wiley and Sons; Polyurethanes, Chemistry and Technology and Applications, Wirpsza, Z., Ellis Horwood, 1993; Handbook of Epoxy Resins, Lee, H. and Neville, K., McGraw-Hill, 1967; Polymer Handbook, Brandrup, J. and Immergut, E. H., John Wiley and Sons, 1989; Alkyd Resin Technology, formulating techniques and allied calculations, Patton, T. C., Intersience, 1962; Handbook of Adhesives, 3^{rd} Edition, Skiest, I., Van Nostrand Reinhold, 1990; Organic Coatings: Science and Technology, Wicks, Z. W. et al, John Wiley and Sons, 2007. Reference will now be made in detail to specific aspects of the disclosed materials, compounds, compositions, articles, and methods, examples of which are illustrated in the accompanying Examples.

All hot-melt coatings referred to in this document are liquefied at elevated temperatures. They are solid at ambient temperature, but the term “solid” as used in this document is not intended to exclude glass-like materials that will flow only very slowly at ambient temperatures, such as over a period of hours. These coatings are solvent-free, which means that the compositions do not rely on solvents as a vehicle for application. The term “solvent-free” is not intended to exclude the presence of a small amount of solvent, e.g. occluded in resins from resin manufacturing processes. Nor does it exclude volatile by-products of cross-linking reactions in coating application and curing. The hot-melt coatings described here comprise less than five percent by weight of volatile materials.

The term “hot-melt coating” used herein refers to a material that can be applied to a surface in order to coat the surface, as well as a material during or after being applied to a surface, either while it remains in the molten state or after cooling and hardening. For example, a compound having the composition shown below in Example 2A can be referred to as a hot-melt coating while in solid form prior to being melted, in molten form prior to or during application to a surface, in molten form after application or in solid form after it has been applied, cooled and solidified. Similarly, the term water-thinned coating refers to a material that includes more than about 2 percent by weight of water in its composition and that can be applied to a surface in order to coat the surface. It also applies to such a material during or after application to a surface, whether it contains water and remains in a liquid state or whether the water has been removed and it is in a solid state. For example, a compound having the composition of Example 2B can be referred to as a water-thinned coating while in liquid form before or during application to a surface, in liquid form after application or in solid form after it has been applied, the water and other volatile materials have been largely removed by evaporation and it is in a solid state.

The term “water-thinned organic protective coating” used herein excludes coatings the dried films of which are comprised largely or entirely of asphalt or bitumen, termed “bituminous coatings”. The term “hot-melt coatings” used herein excludes coatings the films of which are subject to attack, dissolution, swelling, softening or weakening when in contact with water, as the result of short term exposure as opposed to exposure continued for weeks, months or years. An example of such an excluded hot-melt coating is one containing polyvinyl alcohol as a major ingredient, and not chemically cross-linked.

The term “protective coating” is used frequently in this specification to describe water-thinned coatings comprising, in the disclosed invention, coating systems for pavement marking, and to describe both hot-melt coatings and water-thinned coatings comprising, in the disclosed invention, coating systems for application to various surfaces other than pavement. The hot-melt coatings of the invention can provide protection to the underlying substrate from moisture, from oxidation, from corrosion, from airborne mildew spores and to some extent from the harmful actinic radiation of the sun. They can provide protection to subsequently applied coatings from staining by water-soluble colored matter originating in an underlying wood surface, that might otherwise discolor the subsequently applied coating. The water-thinned coatings of the invention can provide protection to the hot-melt coatings from attack by solvents in subsequently applied coatings, from the harmful actinic radiation of the sun, from abuse and from blocking when coated objects are stacked. They can also provide protection to the underlying substrate from solar radiation and to subsequently applied, oxidatively polymerized coatings, from migration of anti-oxidants out of the hot-melt films. The term “protective” implies specific coating ingredients, compositions, properties and film thickness, depending on the kind of protection referred to and on what is being protected. For example, protection of the hot-melt undercoat from abuse requires that a tough and resilient polymer be employed as the principle binder in the water-thinned protective coating, that it adhere tightly to the surface of the hot-melt coating, that it be hardened by judicious selection of pigments and fillers, and that it be applied in a sufficiently thick film to provide protection.

### First Embodiment

### Processes

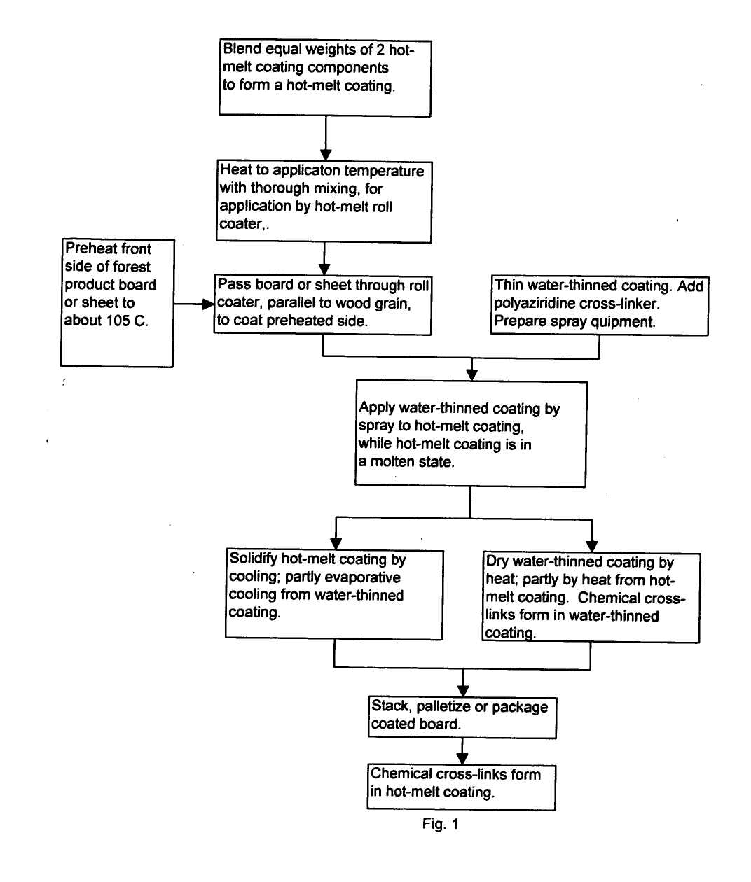

One embodiment of the disclosed process is illustrated by a flowchart in FIG. 1. In accordance with this embodiment, the rolls of a direct roll coater designed for application of hot-melt coatings can be brought to a temperature of about 127° C. to about 150° C., preferably from about 132° C. to about 138° C. A feed pot for the coater can be charged with a hot-melt organic coating similar to a blend of equal weights of the coatings of Example 1A and Example 1B. The feed pot can be brought to the same temperature as the coater and its contents blanketed with an inert gas such as nitrogen or carbon dioxide. A power mixer can intimately mix the molten contents of the feed pot. A portion of the molten mixture can be pumped to the rolls of a direct roll coater through heated pipe or tubing. This pipe or tubing can be equipped with a feed control to coat the rolls and maintain the correct level in the coater, and with in-line filters if required. The roll coater is now ready to apply the hot-melt coating.

A direct roll coater is a coating machine through which the object being coated moves in the same direction as the applicator roll. The configuration and operation of direct roll coaters for application of hot-melt coatings are well known to those skilled in the art.

Preferably, the direct roll coater is equipped for adjustment of the rotational speed of its doctor roll relative to its applicator roll. Further, the doctor roll is set at a rotational speed of about 0 percent to about 80 percent of the rotational speed of the applicator roll during coating application. This method of operation can apply a smoother coat of the hot-melt coating. (cf. Patent EP1543888 A1 (2006) to Minamida et al.)

Each batch of the hot-melt coating can be manufactured according to methods well known to those skilled in the art. Thorough dispersion of any fillers and pigments that are present, and mixing to homogeneity are required. To prepare the hot-melt coating to be charged to the feed pot, at least one batch similar to the Oil Modified Hot-melt Organic Coating Component of Example 1 A and at least one batch similar to the Oil Free Component of Example 1B, can be manufactured. Equal weights of granules formed from each of the two batches are thoroughly blended. At ambient temperature, although the two kinds of solid granules are present in the same container, their solid condition prevents any degree of contact sufficient to permit the initiation of significant chemical reactions involving their ingredients. A vegetable drying oil or oxidizable polymer based on a drying oil can be present in one component of the coating and a metallic soap drier catalyst in the other. Contact between solid granules is not sufficient to cause the catalyst to promote polymerization of the oil. This arrangement assures stability of the coating in storage. When heated to a molten state and intimately mixed, as in the mixing step above, the two components can become a single compounded entity. The catalyst then can become active in promoting polymerization. Such physical separation of mutually reactive components of hot-melt compounds to promote stability is disclosed in U.S. Pat. No. 6,861,464 (2005) to Eadara et al and U.S. Pat. No. 4,517,340 (1985) to Read et al.

The molten mixture of equal parts of the two hot-melt components can have a viscosity, measured at 128° C. using a Brookfield RTV viscometer with a number 28 spindle at 20 revolutions per minute, of about 15 to about 30 pascal-seconds, preferably about 15 to 25 pascal-seconds.

The solid surfaces to be coated can be surfaces of a sheet or board of a forest-product-based material such as wood, hardboard, plywood or oriented strand board, intended for service as an exterior member such as siding or trim in a building or other structure. The side of each board intended to be exposed to the weather can be heated by infrared radiation to raise its surface temperature to about 105° C. The roll coater can be adjusted to apply a hot-melt film thickness of from about 25 to about 125 micrometers, with a preferred range of from about 37 to about 75 micrometers. The sheet of structural material can be passed through it in the direction parallel to any wood grain that the board may exhibit. Thus the preheated side is coated with the desired thickness of hot-melt coating.

A method of hot-melt coating application alternative to roll coating is curtain coating. However, the film thickness attainable may not be the same unless the coating is specifically formulated for the curtain coater. In particular, viscosity as measured at 128° C. using a Brookfield RTV viscometer with a number 28 spindle at 20 revolutions per minute, can be from about 2 to about 15 pascal-seconds. For formulations comprising tung oil in a concentration similar to that which is present in an equal parts blend of the formulas in Example 1A and 1B, application temperature can be as previously specified. Methods of application of hot-melt coatings by curtain coating are well known to those skilled in the art.

The relatively low application temperature previously specified is desirable to enhance coating stability in the presence of tung oil in the hot-melt coating formed by combining Example 1A and Example 1B. It also, however, places emphasis on the control of application temperature within a narrow and accurately measured range. Hot-melt coatings of the type employed here are capable of tenacious adhesion, but only when applied at a sufficiently high temperature to permit thorough wetting of the substrate before the coating cools. Limiting the application temperature can provide a lower factor of safety for assurance of good adhesion than would a higher temperature, and thus can necessitate close attention to this aspect of application. Operation at a higher temperature within the specified range can facilitate application of a lower film thickness by reducing coating viscosity.

The surface, comprising a film of hot-melt coating spread over a solid surface, is now ready to receive the application of a water-thinned coating similar to that of Example 1C. The method of manufacture of the water-thinned coating is well known to those skilled in the art. A predetermined quantity can be prepared for spray application by adding a polyaziridine additive similar to that in Example 1C, to promote chemical cross-linking. The coating can be thinned with water to a viscosity suitable for spray, and thoroughly mixed. Suitable properly adjusted spray equipment is employed, according to methods well known to those skilled in the art.

Within a period of time ranging from less than one second to several seconds after the hot-melt coating is applied, but in any case while it is in a molten state, the water-thinned coating is sprayed onto the hot-melt surface. The desired film thickness of the water-thinned coating after drying can be from about 10 to about 50 micrometers, preferably from about 12 to about 25 micrometers. The water-thinned coating can be immediately dried by heat, including heat absorbed from the hot-melt coating. Infrared heat can also be applied to its surface or heated air can be moved over it, for about two minutes or more. Or a combination of the two sources of heat can be used. As the water-thinned coating dries, the hot-melt coating solidifies by cooling. The difference in their initial temperature makes possible the simultaneous heating and cooling of different coats in the same coating system. This process can be aided by evaporative cooling as the water leaves the water-thinned coating. Sheets or boards of coated material can then be stacked, although a brief cooling period is desirable.

Alternative methods of application of the water-thinned coating of this embodiment are by curtain coater or roll coater. Adjustment in formulation may be necessary for optimum performance. Whatever method is used, application of the water-thinned coating is accomplished while the hot-melt coating is in the molten state, and the desired film thickness of the water-thinned coating, after drying, is the same for all methods of application.

Formation of chemical cross-links in the hot-melt coating film composed of equal parts Example 1A and 1B can be accomplished by oxidative polymerization of the tung oil within about two weeks after coating application. The time required can be longer or shorter depending on the temperature of storage of the coated board and on the degree of access of the coated surface to air. The time to cross-link can vary if drying oils or polymers other than tung oil are employed, or if the choice or concentration of metallic soap dryer catalysts, or the choice or concentration of antioxidant, is varied. Formation of chemical cross-links in the water-thinned coating film of Example 1C, which includes a polyaziridine cross-linking agent, can be accomplished during the process of drying the water-thinned coating.

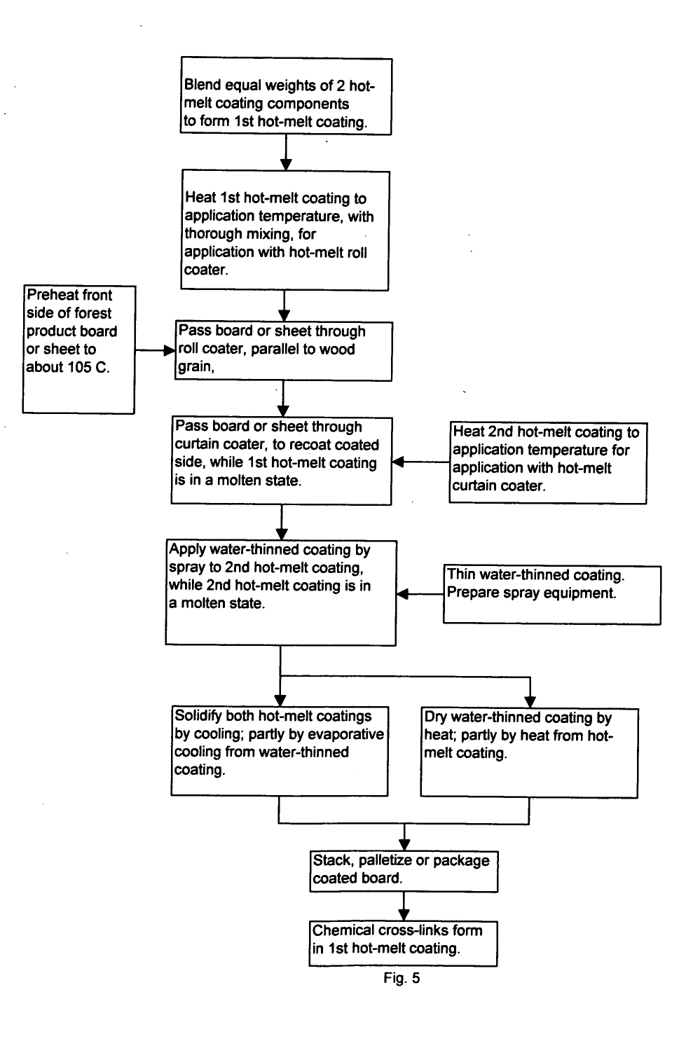

As an alternative, illustrated by a flow-chart in FIG. 5, this embodiment can be modified by applying a second hot-melt organic coating to the surface of the first hot-melt coating, immediately after its application and prior to application of the water-thinned coating. Roll coating or curtain coating can be used to apply the second hot-melt coat, as with the first. Application of the water-thinned coating to the surface of the second hot-melt coating employs the same method as if it were applied to the first. The two hot-melt coatings can have different compositions and specific purposes. Hot-melt coating application temperatures and film thicknesses can be varied as appropriate for the coating compositions and the purpose intended.

As an example of an advantageous use of this modification of the embodiment, the two hot-melt coats can be designed to enhance, synergistically with each other, the performance of the coating system on a sanded plywood surface. The first coat can be designed to promote penetration into the wood by components of the coating, and their subsequent polymerization to improve adhesion and stabilize the surface. The second coat can then be designed for maximum flexibility and extensibility, to minimize cracking of the coating by the anticipated cracking, along the grain, of the outer wood veneer.

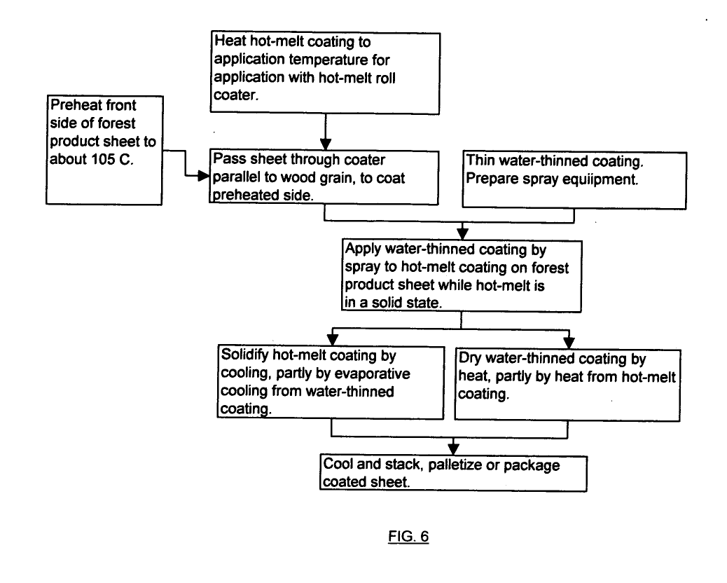

The timing of the application of the water-thinned coating, to insure that the hot-melt coating is in the molten state, is particularly desirable for demanding service conditions such as exterior exposure. For less demanding service requirements, the water-thinned coating of Example 1C can be applied to the surface of the hot-melt coating composed of equal parts Examples 1A and 1B, after the hot-melt coating has solidified. This is illustrated by a flow-chart in FIG. 6.

In describing the coating process herein; it has been assumed that the surface to be coated is initially at ambient temperature. This will not be the case if the coating system is applied as part of a manufacturing process, such as manufacture of hardboard or oriented strand board, where the product is hot as it exits the fabrication line. Depending on the exact surface temperature, addition of heat may not be advantageous, since it will consume costly energy and also will slow the process of ultimately cooling the board. The purpose of preheating the board, as described above, is to dry the surface to avoid blistering of the coating by moisture driven out, since hot-melt application temperature generally exceeds the boiling point of water. The board will not require preheating if it has been heated sufficiently during fabrication. The heat in the board can also reduce or eliminate the need to apply heat to dry the water-thinned coating. The drying process indicated by these conditions can consist of forcing a volume of heated or unheated air over the surface, to carry away the moisture vapor from the water-thinned coating. The process of evaporation of water from the water-thinned coating can be capable of cooling the surface of the heated board by several degrees, depending on the thickness of the coating and on the thickness, heat capacity and heat transmission properties of the board. Such cooling is desirable for rapid solidification of the hot-melt coating and easier stacking. Since higher water-thinned coating film thickness means an increased volume of the water contained in it and available for evaporative cooling of the board, it may be seen that there can be a relationship between the thickness of the water-thinned coating and the time required to cool the board to permit stacking. Very thin films of water-thinned coating can be undesirable for this reason as well as for their more limited protective value.

Heating the water-thinned coating to dry it, whether by use of an external source or by utilizing heat resident in the board, can serve another purpose besides accelerating the coating process. It also can coalesce the latex particles into a continuous film, making it unnecessary to include, in the coating composition, potentially polluting, toxic and flammable organic solvents that are commonly used for this purpose when heat is not available.

A direct roll coater coats only the face of the board and not the edges. If it is desired to coat one or more edges, such as the bottom edge of a board intended as lap siding, an additional hot-melt coating application process can be employed. It can utilize a hot-melt ribbon coater to apply a hot-melt coating film of about 30 micrometers to about 60 micrometers to the intended edge. The board can be positioned on a conveyor by properly placed guides and thus its edge can be brought into contact with the ribbon coater. The edge can be prepared, such as by sanding, and also by filling if the board has rough edges as plywood often does. The ribbon coater can use the same hot-melt coating feed pot as the roll coater.

The water-thinned coating can be readily applied to edges by spray. Or if a curtain coater is used to coat the face of the board, one or two edges can be coated simultaneously with the face by proper positioning on the curtain coater conveyor.

### First Embodiment

### Articles and Compositions

Also disclosed herein is a sheet or board of material coated with the disclosed coating systems. Such material, coated on appropriate sides and edges, is typically comprised of forest products. It can be intended for service as an exterior structural surface member, such as siding or trim comprised of plywood, hardboard, wood, oriented strand board or other forest product material. The coating system comprises a first coat of hot-melt coating and a final coat of a water-thinned coating, omitting the optional second coat of hot-melt coating. Its purpose can be to serve as a primer applied at the point of manufacture. This primer can be intended to be further coated with one or more coats of conventional architectural finish paint after erection of a structure. Film thickness of the hot-melt coating can be from about 25 to about 125 micrometers, preferably from about 37 to about 75 micrometers. Film thickness of the water thinned coating after drying can be from about 10 to about 50 micrometers, preferably from about 12 to about 25 micrometers.

The hot-melt coating can be adhered to the surface of the substrate that will be exposed to the weather. It can be similar in composition to equal parts by weight of Example 1A, Oil Modified Hot-melt Organic Coating Component, and Example 1B, Oil Free Component. It can comprise copolymers of ethylene and vinyl acetate, and also can comprise one or more vegetable drying oils. As an alternative to the vegetable oils it can comprise synthetic resins capable of polymerization by oxidation and formed by chemical combination of vegetable oils with some or all of the group of chemical entities that includes polyols, polyfunctional carboxylic acids, rosin, polyfunctional isocyanates and glycidyl ethers. One or more metallic soap drier catalyst, designed to promote polymerization, can also be present. Any member of the group of oils comprising tung oil, oiticica oil or dehydrated castor oil is the preferred drying oil. Drying oils are capable in many situations of penetrating the surface of wood and subsequently polymerizing, thus enhancing adhesion and stabilizing the surface.

Inclusion of an oil or resin capable of polymerization by oxidation produces a film that can be hardened by development of chemical cross-linking. Such a hardened film, produced by this or by another method of chemical cross-linking, is preferred in hot-melt coatings that form part of a coating system on permanently exposed exterior surfaces. It enhances performance when these surfaces are located in warm climates and finished with dark colors. In such circumstances, when coatings are directly exposed to the weather, absorption of energy from the sun can raise surface temperatures high enough to soften some hot-melt coatings that are not chemically cross-linked. In any multi-coat organic coating film, if the undercoat becomes significantly softer than subsequent coats, failure in the form of blistering, cracking or alligatoring can occur. Chemical cross-linking is capable of raising the softening point of a hot-melt coating film well above any reasonably expected service temperature. When a hot-melt coating forms part of a coating system on a surface subject to more moderate service temperatures, and is not designed for chemical cross-linking, coating components having softening points or melting points near or in excess of about 100° C. are preferred.

The hot melt coatings disclosed herein can contain less than about 25, 24, 23, 22, 21, 20, 19, 18, 17, 16, 15, 14, 13, 12, 11, 10, 9, 8, 7, 6, 5, 4, 3, 2, 1, or 0.5 percent by weight of a hydrogenated block copolymer, based on total polymer contained in the coating, where any of the stated values can form the upper or lower endpoint of a range.

The hot-melt coating can also comprise particulate mineral or synthetic inorganic filler for greater hardness, pigment selected for absorption of the ultra-violet component of sunlight, pigment selected to provide a film having a desired color; and substances comprised of or derived from polyethylene or wax, for reduction of viscosity. Additionally, it can comprise additives such as anti-oxidants for stability and acid acceptors for durability.

For assured adhesion of water-thinned coatings to the hot-melt film, compatibility between each hot-melt ingredient and all other ingredients, at the concentration of each ingredient found in the particular composition, is essential. “Compatibility” is defined here as the capability to readily and permanently form an intimate mixture with each other ingredient present and with all other ingredients in composite, to the extent that no ingredient will subsequently separate from the mixture. Compatibility prevents interference with intercoat adhesion by a separated ingredient that could float to the surface of the hot-melt film and form a weak layer in the final multi-coat film.

Copolymers of ethylene and vinyl acetate selected for use in the hot-melt coating comprise a minimum of about 27 percent by weight of vinyl acetate. Terpolymers of ethylene, vinyl acetate and an acrylic acid can be used to replace a portion of the copolymer. These polymer compositions, along with the presence of a vegetable drying oil or a related resin, can be employed to minimize interfacial tension between water-thinned paint and the hot-melt surface. Lower interfacial tension promotes more efficient wetting of the surface and development of adequate intercoat adhesion.

Anti-oxidants are typically necessary for hot-melt stability. They can be selected for high molecular weight and low tendency to migrate out of the hot-melt film. Anti-oxidant concentration should be carefully limited. It can be established at the minimum level required for stability or, alternatively, the maximum level that will not retard the drying of a subsequent coat of a coating that polymerizes by oxidation. These factors and the presence of the water-thinned coating can prevent migration of anti-oxidants into subsequently applied coatings. Conventional oil house paint, for example, can be applied over the disclosed coating system after installation of coated siding on a structure, without lengthening the time the oil paint requires to dry. The same considerations can be important in selecting anti-oxidants so that they will not unnecessarily delay cross-linking after application of the coating, when the hot-melt coating comprises a drying oil.

The water-thinned coating can be adhered to the hot-melt coating. Its composition can be similar to that of a dried film cast from the coating of Example 1C. In addition to water, it can be comprised of opaque pigments and particulate fillers dispersed in one or more latex emulsions. In these emulsions, the preferred principal non-volatile binders are copolymers based on acrylates and/or vinyl acetate, or other polymers suitable for preparation of latex emulsions for use in exterior paint. Preferred latex emulsions will continue to adhere when their dried films are wetted with water. Preferred latex polymers have particle sizes from about 10 to about 500 nanometers, molecular weights from about 10,000 to about 5,000,000 and glass transition temperatures from about −20° C. to about 40° C. Small latex particle size and lower glass transition temperature can help the latex particles in the coating to coalesce quickly and with less energy input during the drying process. Some latex emulsions in which polymers of different composition are present in the same particle, with a core/shell or lobe-type configuration, can be useful for achieving lower temperature coalescence and good block resistance at the same time.

Other ingredients in the water-thinned coating can be additives customarily used in such coatings. These can include but are not limited to additives for pigment dispersion, viscosity control, stability, protection from bacterial attack, and foam control. A fungicidal or fungistatic additive can also be present. Through the substitution of suitably chosen pigments alternative to those shown in Example 1C, the coating can be produced in a broad variety of colors.

As shown in Example 1C, the water-thinned coating can be formulated with a ratio of combined pigments and fillers to total non-volatile materials that exceeds its critical pigment volume concentration (CPVC). The CPVC is a specific volume proportion of combined pigments and fillers to total non-volatile content including non-volatile binder. At CPVC the binder wets all of the pigment and filler particle surface area and fills all voids between particles, but has no capacity to wet additional particles. When the CPVC is exceeded, the dried film becomes porous, transmitting moisture more readily and offering less protection to the substrate. Methods of determining the necessary loading of pigment and filler to achieve CPVC are well known to those skilled in the art. (cf. U.S. Pat. No. 4,525,518 (1985) to Kostansek; Asbeck, W. K., “A Critical Look at CPVC Performance and Application Properties,” JCT, 64 (806):47, 1992; Bierwagen, G. P. and Hay, T. K., “The Reduced Pigment Volume Concentration as an Important Parameter in Interpreting and Predicting the Properties of Organic Coatings”, Prog. Org. Coat., 3:281, 1975)

However, when the water-thinned coating is used over a hot-melt coating in a system intended as a primer, this unconventionally high pigment loading can have advantages. It often detracts very little from durability, can contribute to block resistance and also can contribute to keeping the moisture permeability of the two-coat system in a desirable range. The highly pigmented film can exhibit the ability to prevent properly selected anti-oxidant additives present in the hot-melt coating from migrating into oxidizing-type finishes. When the water-thinned coating is formulated to exceed its CPVC, it is preferred that it be used over a hot-melt coating capable of chemical cross-linking.

When further improvement in block resistance is needed and all necessary conditions are met, a polyaziridine additive can be used as in Example 1C, or another compatible substance capable of forming chemical cross-links in the latex polymer can be used. The necessary conditions for successful cross-linking using polyaziridine additive include the presence in the formulation of a latex polymer with available carboxyl groups, and the absence of other carboxyl-functional substances. The non-volatile chemical entities contained in the water-thinned coating of Example 1C prior to addition of the polyaziridine are incapable of forming chemical cross-links. Addition of the polyaziridine to a coating that includes polymers reactive with it can provide the means of forming chemical cross-links and increasing the hardness and toughness of the water-thinned coating film. The cross-linking mechanism is by formation of aminoester links between polymer molecules, via their carboxyl groups.

Polyaziridine should not be added until immediately before application of the coating because it is subject to hydrolysis by the water in the coating, over a period of 2 to 3 days, which can convert the additive to a non-reactive substance. If the coating has not been applied to a surface during this period, addition of more polyaziridine can re-establish the effectiveness of the additive. The preferred level of polyaziridine is 3 percent calculated on non-volatile latex polymer.

### Examples of Formulas for Coatings Used in the First Embodiment

### Example 1A

### Oil Modified Hot-Melt Organic Coating Component

| | Percent by |
|---|---|
| Ingredient | weight |
| Copolymer of ethylene and vinyl acetate, | 19.0 |
| 40% vinyl acetate, melt index 52 | |
| Copolymer of ethylene and vinyl acetate, | 25.0 |
| 28% vinyl acetate, melt index 800 | |
| Tung oil | 22.4 |
| Oxidized polyethylene, melting point 91° C., | 7.8 |
| acid number 30, saponification number 59, | |
| Brookfield viscosity at 240° F. 0.18 Pa · s | |
| Silica-alumna ceramic spheres, density 2.5 g/cm³, | 23.0 |
| median particle diameter 4 micrometers, | |
| effective maximum particle diameter 12 micrometers | |
| Calcium carbonate, median particle diameter 5 micrometers, | 2.0 |
| maximum particle diameter 44 micrometers | |
| Anti-oxidant, Irganox 1010, Ciba-Geigy Corporation, | 0.8 |
| Plastics and Additives Division, Hawthorne, New York | |

### Example 1B

### Oil Free Hot-Melt Organic Coating Component

| | Percent by |
|---|---|
| Ingredient | weight |
| Copolymer of ethylene and vinyl acetate, | 19.0 |
| 40% vinyl acetate, melt index 52 | |
| Copolymer of ethylene and vinyl acetate, | 14.2 |
| 28% vinyl acetate, melt index 800 | |
| Oxidized polyethylene, melting point 91° C., | 41.2 |
| acid number 30, saponification number 59, | |
| Brookfield viscosity at 240° F. 0.18 Pa · s | |
| Silica-alumna ceramic spheres, density 2.5 micrometers, | 23.0 |
| median particle diameter 4 micrometers, | |
| effective maximum diameter 12 micrometers | |
| Calcium carbonate, median particle diameter | 2.0 |
| 5 micrometers, maximum particle diameter 44 micrometers | |
| Anti-oxidant, Irganox 1010, Ciba-Geigy Corporation, | 0.2 |
| Plastics and Additives Division, Hawthorne, New York | |
| Cobalt soap drier catalyst solution in mineral spirits | 0.4 |
| or related organic solvent, 12% cobalt | |

### Example 1C

### White Water-Thinned Organic Coating

| | Percent by |
|---|---|
| Ingredient | weight |
| Water | 31.1 |
| Defoamer, Colloids 697, Kemira Chemicals Inc., | 0.45 |
| Kennesaw, Georgia | |
| Preservative, Kathon LX 1.5%, Rohm and Haas Company, | 0.08 |
| Philadelphia, Pennsylvania | |
| Hydroxyethylcellulose thickener, Natrosol 250 HHBR, | 0.26 |
| Hercules, Inc., Wilmington, Delaware | |
| Dispersant, Tamol 1124, Rohm and Haas Company, | 0.83 |
| Philadelphia, Pennsylvania | |
| Surfactant, Triton CF-10, Rohm and Haas Company, | 0.21 |
| Philadelphia, Pennsylvania | |
| Titanium dioxide pigment, alumina surface treatment, | 20.6 |
| specific gravity 4.1, oil absorption 18, average | |
| particle size 0.19 micrometers, ASTM D-476-00 Types II, | |
| III | |
| Nepheline syenite filler, specific gravity 2.6, median | 12.5 |
| particle diameter 3.5 micrometers, maximum particle | |
| diameter 44 micrometers, oil absorption 31, brightness | |
| (TAPPI) 89.2 | |
| Calcined clay, specific gravity 2.2, average particle | 10.4 |
| diameter 1.4 micrometers, maximum particle diameter | |
| 44 micrometers, GE brightness 83 | |
| Diatomaceous silica, specific gravity 2.1, average | 2.7 |
| particle diameter 2 micrometers, maximum particle | |
| diameter 44 micrometers, dry brightness 94 | |
| Acrylic latex emulsion, Multilobe 200, Rohm and Haas | 20.6 |
| Company, Philadelphia, Pennsylvania | |
| Ammonia solution, 28° Baume | 0.17 |
| Colortrend Universal Machine Colorant 888-9907B, | trace* |
| Lampblack, DeGussa Corporation, Coatings and Colorants | |
| Division, Piscataway, New Jersey | |

*Add colorant until the reflectance of an opaque dried film of the coating is reduced to about 0.8.

Before applying the White Water-thinned Organic Coating of this example to the surface of a hot-melt coating, prepare the following polyaziridine solution and add it in the proportion of 118 cm³ (4 fluid ounces) of polyaziridine solution to 3.785 liters (one gallon) of Water-thinned Organic Coating:

| Ingredient | Amount |
|---|---|
| NeoCryl CX-100, DSM Neoresins, | 20 cm³ (⅔ fluid ounce) |
| Waalwijk, Netherlands | |
| Water | 99 cm⁵ (3⅓ fluid ounces) |

Add the polyaziridine solution to the water-thinned coating and apply the coating within 2 days after preparation of the solution. If necessary to delay longer, prepare fresh polyaziridine solution and add it to the coating in the same proportions.

### Second Embodiment

### Processes

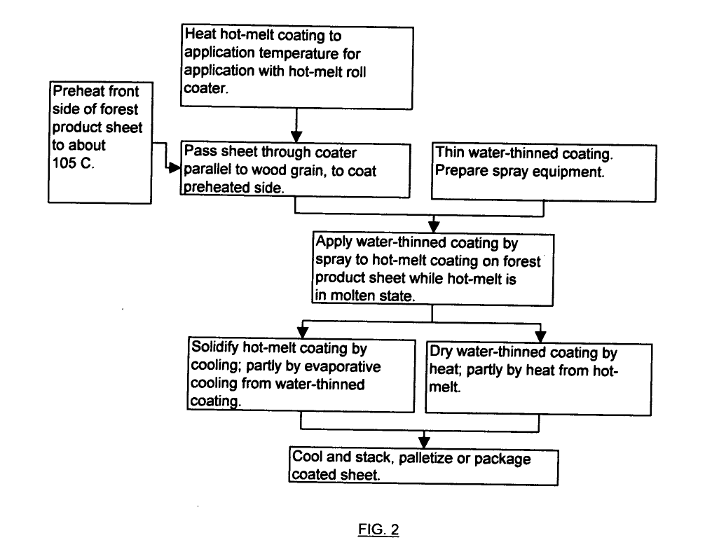

Another embodiment of the disclosed process is illustrated by a flowchart in FIG. 2. In accordance with this embodiment, the rolls of a direct roll coater designed for application of hot-melt coatings can be brought to a temperature of about 170° C. to about 200° C., preferably from about 178° C. to about 188° C. A feed pot for the coater can be charged with a hot-melt coating similar to Example 2A and brought to the same temperature as the roll coater. The roll coater can be adjusted to apply a hot-melt coating film thickness of about 25 to about 125 micrometers, with a preferred range of about 37 to about 75 micrometers. Hot-melt coatings such as that of Example 2A are manufactured according to methods well known to those skilled in the art. Thorough dispersion of any fillers and pigments that are present, and mixing to homogeneity are required.

As in the first embodiment described above, it is preferred that the direct roll coater be equipped for adjustment of the rotational speed of its doctor roll relative to its applicator roll. The doctor roll can be set at a rotational speed of about 0 percent to about 80 percent of the rotational speed of the applicator roll. A portion of the molten coating can be pumped to the rolls of the roll coater through heated pipe or tubing equipped with a feed control to coat the rolls and maintain the correct level in the coater, and with in-line filters if required. The roll coater is now ready to apply the hot-melt coating.

The viscosity of the hot-melt coating of this embodiment, measured at about 182° C. using a Brookfield RTV viscometer with a number 28 spindle at 20 revolutions per minute, can be about 15 to about 30 pascal-seconds, preferably 15 to 25 pascal-seconds.

The solid surface to be coated can be the surface of a sheet or board of a composite forest product material. It can be intended for service as a structural component of a building, such as sheathing or roof decking, that in normal construction practice will be only temporarily exposed to the weather. Such composites can, as in this instance, require a protective coating to prevent weather damage during temporary exposure. The side of the sheet or board that is intended for exposure to weather can be heated by infrared radiation to raise its surface temperature to about 105° C. The sheet of composite forest product material can be passed through the coater in a direction parallel to any wood grain that the sheet may exhibit. Thus the preheated side can be coated with the desired thickness of hot-melt coating. The surface is now ready for application of a water-thinned coating.

As described under the first embodiment, a curtain coater may be used as an alternative method of hot-melt application. The comments and restrictions noted under the first embodiment, when using a curtain coater, also apply to this embodiment.

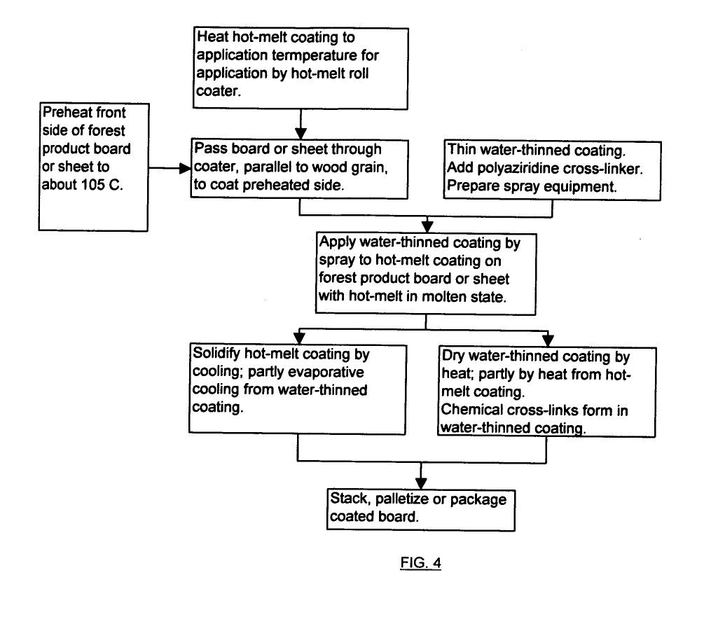

A predetermined quantity of water-thinned coating similar to the coating of Example 2B can be prepared for spray application. The process can be similar to that described for the first embodiment. The polyaziridine additive of Example 1C may be omitted or if the water-thinned coating has suitable composition as described under the first embodiment, the additive may be used. This process is illustrated by a flow-chart in FIG. 4, with the water-thinned coating cross-linked by polyaziridine. Within a period of time ranging from less than one second to several seconds after the hot-melt coating is applied, but in any case while it is still molten, the water-thinned coating can be sprayed onto the hot-melt surface. The desired film thickness of the water-thinned coating after drying can be from about 10 to about 50 micrometers, preferably from about 12 to about 25 micrometers.

The water-thinned coating can be immediately dried by heat, including heat absorbed from the hot-melt coating. Infrared heat can also be applied to its surface or heated air can be moved over it, for about two minutes or more, or a combination of the two can be used. As the water-thinned coating dries, the hot-melt coating can solidify by cooling. The difference in their initial temperature can make possible the simultaneous heating and cooling of different coats in the same coating system. The process can be aided by evaporative cooling as the water leaves the water-thinned coating. Sheets or boards of coated material can then cooled and stacked.

Alternative methods of application of the water-thinned coating of this embodiment are by curtain coater or roll coater, but adjustment of the coating formulation may be required for optimum performance using one of these options. Whatever method is used, application of the water-thinned coating is accomplished while the hot-melt coating is in the molten state, the desired film thickness of the water-thinned coating, after drying, is the same and the drying process is the same.

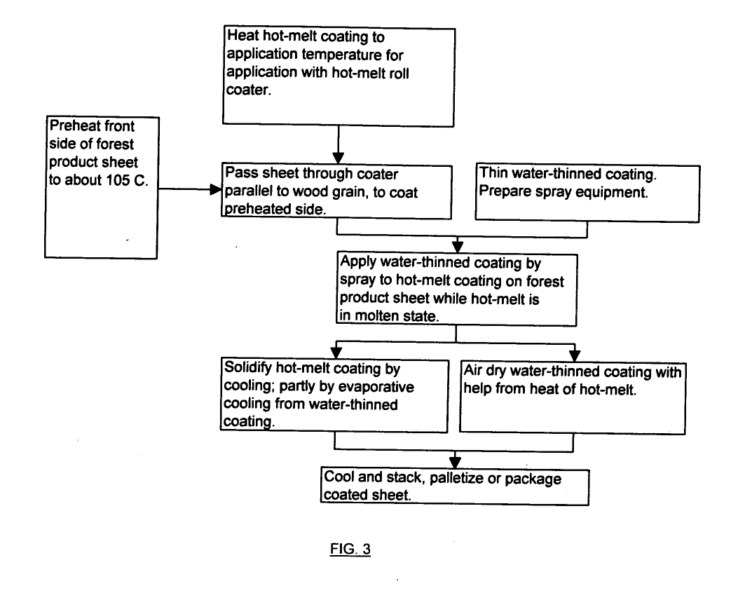

An alternative drying process, illustrated in FIG. 3 by a flow-chart, is to air dry with no external heat applied. This option can cause the time required before coated articles can be stacked to be considerably longer, and can also make it necessary to include organic solvent in the water-thinned coating to soften its latex particles and assist in their coalescence during film formation.

Edges of the board can also be coated both with hot-melt coating and water-thinned coating, using the methods described for the first embodiment.

In describing the coating process, it has been assumed that the surface to be coated is initially at ambient temperature. This will not be the case if, as described for the first embodiment, the coating is being applied to hot articles as they come off a fabrication line immediately after manufacture. In such a situation, as previously described, an alternative process for drying the water-thinned paint can be more desirable.

### Second Embodiment

### Articles and Compositions

Also disclosed herein is a sheet or board of composite material that is coated by the coating system disclosed herein. Such an article, coated on appropriate sides and edges, can be based on forest products. It can be intended for service as a structural member that in normal construction practices will be only temporarily exposed to the weather. Such members can be sheathing or roof decking. The coating systems can comprise a first coat of a hot-melt coating and a second coat of a water-thinned coating. The purpose of the coating system can be to serve as a finish to protect the structural member during the period between its installation and the installation of other parts of the structure that will ultimately shield it from the weather. The hot-melt coating film thickness can be from about 25 to about 125 micrometers, preferably from about 37 to about 75 micrometers. The water-thinned coating film thickness after drying can be from about 10 to about 50 micrometers, preferably from about 12 to about 25 micrometers.

The hot-melt coating can be adhered to the board surfaces that will be exposed to weather during construction. It can be similar in composition to the hot-melt coating of Example 2A. Its composition comprises copolymers of ethylene and vinyl acetate, and also may comprise one or more terpolymers of ethylene, vinyl acetate and an acrylic acid. It can comprise one or more polymers, such as rosin esters, that are less hydrophobic than copolymers of ethylene and vinyl acetate. Such ingredients can be permissible when long-term resistance to weather is not required. By increasing the moisture permeability of the hot-melt film they can permit the more rapid escape of moisture from the structure and help to prevent condensation in undesirable places within the structure. They also can help to reduce the interfacial tension between the hot-melt coating and the water-thinned coating. The chemical entities that comprise the hot-melt coating of Example 2A are incapable of the formation of chemical cross-links.

Other ingredients can comprise particulate filler for greater hardness, pigment selected to absorb the ultra-violet component of sunlight, pigment selected to provide a desired color, and substances comprised of or derived from polyethylene or wax, for reduction of viscosity. Additives such as anti-oxidants and acid acceptors can be present. As previously explained, compatibility between each hot-melt ingredient and all other ingredients is essential for assured adhesion of water-thinned coatings to the hot-melt film.

The water-thinned coating can be adhered to the hot-melt coating. Its composition can be similar to that of a dried film cast from the coating of Example 2B. It can be comprised of water and of opaque pigments and particulate fillers dispersed in a latex emulsion as described under the first embodiment. It can also comprise customary additives for the purposes listed under that embodiment. It can comprise a fungicidal or fungistatic additive.

Since the water-thinned coating in this embodiment can be intended as a finish coat, it can be particularly desirable that its color be other than the white color of Example 2B. By appropriate selection of suitable colored pigments substituted in whole or in part for the titanium dioxide pigment in the example, the coating can be produced in a broad variety of colors.

### Examples of Formulas for Coatings Used in the Second Embodiment

### Example 2A

### Hot-Melt Organic Coating

| | Percent by |
|---|---|
| Ingredient | weight |
| Copolymer of ethylene and vinyl acetate, | 24.0 |
| 40% vinyl acetate, melt index 52 | |
| Copolymer of ethylene and vinyl acetate, | 13.0 |
| 28% vinyl acetate, melt index 800 | |
| Elvax 4310, DuPont Packaging and Industrial Polymers, | 15.0 |
| Wilmington, Delaware | |
| Pentaerythritol ester of rosin, softening point | 7.0 |
| (Ring and Ball) 105° C., acid number 13, | |
| Gardner color 4, melt viscosity 0.28 Pa · s | |
| at 177° C. | |
| Oxidized polyethylene, melting point 91° C., | 15.5 |
| acid number 30, saponification number 59, Brookfield | |
| viscosity at 240° F. 0.18 Pa · s | |
| Silica-alumna ceramic spheres, density 2.5 micrometers, | 23.0 |
| median particle diameter 4 micrometers, effective | |
| maximum diameter 12 micrometers | |
| Calcium carbonate, median particle diameter | 2.0 |
| 5 micrometers, maximum particle diameter 44 micrometers | |
| Anti-oxidant, Irganox 1010, Ciba-Geigy Corporation, | 0.5 |
| Plastics and Additives Division, Hawthorne, New York | |

### Example 2B

### White Water-Thinned Organic Coating

| | Percent by |
|---|---|
| Ingredient | weight |
| Water | 19.9 |
| Preservative, Nuosept 95, International Specialty | 0.18 |
| Products, Wayne, New Jersey | |
| Propylene glycol | 3.6 |
| Cellulosic thickener, Natrosol Plus 330, Hercules, | 0.31 |
| Inc., Aqualon Division, Wilmington, Delaware | |
| 2-amino, 2-methyl propanol, 95% solution in water | 0.31 |
| Defoamer, Colloids 697, Kemira Chemicals Inc., | 0.81 |
| Kennesaw, Georgia | |
| Surfactant, Triton DF-16, Rohm and Haas Company, | 0.27 |
| Philadelphia, Pennsylvania | |
| Dispersant, Tamol 1124, Rohm and Haas Company, | 0.67 |
| Philadelphia, Pennsylvania | |
| Titanium dioxide pigment, alumina surface treatment, | 22.4 |
| specific gravity 4.1, oil absorption 18, average | |
| particle diameter 0.19 micrometers, ASTM D-476-00 | |
| Types II, III | |
| Nepheline syenite filler, specific gravity 2.6, | 3.1 |
| median particle diameter 3.5 micrometers, maximum | |
| particle diameter 44 micrometers, oil absorption | |
| 31, brightness (TAPPI) 89.2 | |
| Nepheline syenite filler, specific gravity 2.6, | 3.1 |
| median particle diameter 7.5 micrometers, maximum | |
| particle diameter 44 micrometers, oil absorption | |
| 27, brightness (TAPPI) 89.2 | |
| Wollastonite, Hegman fineness 3.5 minimum, maximum | 0.9 |
| particle diameter 44 micrometers, Photovolt brightness | |
| dry 80 minimum | |
| Associative Rheology Modifier, Acrysol RM1020, | 0.9 |
| Rohm and Haas Company, Philadelphia, Pennsylvania | |
| Diatomaceous silica, Celite 499, Celite Corporation, | 1.3 |
| Goleta, California | |
| Acrylic latex emulsion, Fulatex PD461, H. B. Fuller | 10.6 |
| Company, St. Paul, Minnesota | |
| Latex emulsion, copolymer of vinyl acetate and one | 29.2 |
| or more acrylates, Fulatex PD124, H. B. Fuller Company, | |
| St. Paul, Minnesota | |
| Fungicide, Polyphase P100, Troy Corporation, New York, | 2.0 |
| New York | |

### Additional Uses

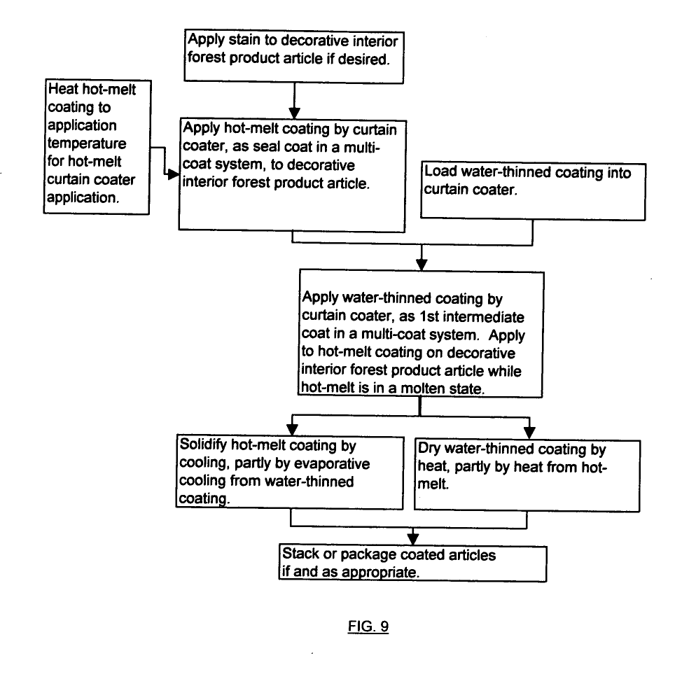

The disclosed coating system can be adapted to many different uses including the coating of interior paneling and other decorative interior surfaces. In FIG. 9 is a flow-chart that illustrates the process of application of the disclosed coating system as the base for a multi-coat decorative and protective system on interior articles. In this instance, the system can comprise a hot-melt coating as the seal coat in a multi-coat finishing system, together with the first water-thinned intermediate coat or finish coat applied over it by the methods described above for embodiments. The hot-melt coating can effectively seal in any water-soluble colored matter present in the wood, and not raise the grain. The two-coat system can form an excellent base for subsequent coats. It can provide near-instantaneous drying of the seal coat. It can also overcome the limitations that the more customary UV coatings place on pigmentation of the seal coat and can avoid the toxicity associated with UV coatings.

Application of the hot-melt seal coat by curtain coater is preferred to roll coating on interior surfaces. The reason is that the surface smoothness achievable by roll coating, while satisfactory for exterior surfaces, may not be as suitable for interior surfaces. Lower hot-melt viscosity compared to viscosity required for roll coating, is desirable when curtain coating, in order to permit control of hot-melt film thickness at desirable levels. This has been discussed previously.

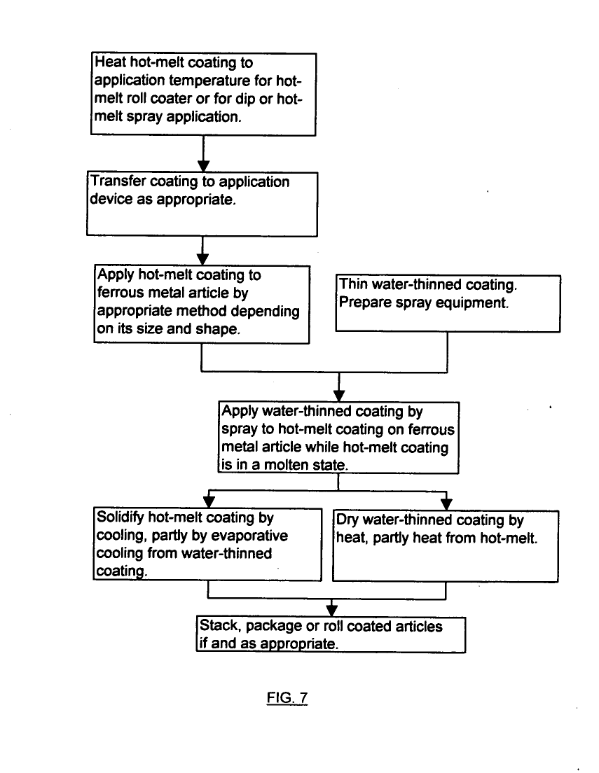

In another example of the numerous possible useful purposes of the disclosed coating system, it can be used as an anticorrosive primer coating applied at the point of manufacture of articles made of ferrous metals, for temporary protection and in anticipation of the application of additional coatings. Or it can be applied to ferrous metal articles as a protective finish. Patents referenced above under “Background” disclose metal-protective hot-melt coatings. Thus anticorrosive hot-melt coatings for steel are practical. But these patented coatings depend on chemical cross-linking reactions that must be carried out in the coating film after application, to achieve a tough, tack-free surface. When the coating system disclosed herein functions as an anticorrosive factory-applied primer, it can achieve a tough, tack-free surface without further processing, by application and drying of the water-thinned coating over the hot-melt. At the same time, the water-thinned coating can greatly improve the exterior durability of the surface and extend the period during which it is easily recoatable. In FIG. 7 a flow-chart illustrates the process of application of the disclosed coating system to ferrous metal.

Another advantage that can accrue is the use of thicker metal protective films than might otherwise be useful. The freedom of hot-melt films from solvent retained after drying, and their high film integrity, contribute to this. However, thick films of any kind of coating, including hot-melt, can tend to sag, run or slump in a way that is unsightly and also detracts from protective properties. The disclosed coating system can overcome sagging because the chilling effect of the quickly applied water-thinned coating can solidify the hot-melt coating before it sags.

On steel intended to be formed after coating, very thin primer coatings are often necessary in order to permit forming of the steel without cracking the coating. Such thin coatings are less effective in protecting the steel. The high extensibility and great flexibility achievable through the use of combined hot-melt and water-thinned coatings can enhance the formability of thicker, more protective films.

The above referenced patented metal coatings provide some examples of the various non-volatile chemical entities that have been incorporated into hot-melt coatings and adhesives to provide means of forming chemical cross-links. These include the incorporation into the hot-melt coating of moisture-cured urethane polymers and of numerous different pairs or groups of chemical co-reactants. Cross-linking can materially improve the performance of the coating or adhesive. The use of these alternative means of cross-linking to enhance hot-melt coatings suitable for the coating system disclosed herein affords opportunities for diverse uses of that system, beyond protection of ferrous metals.

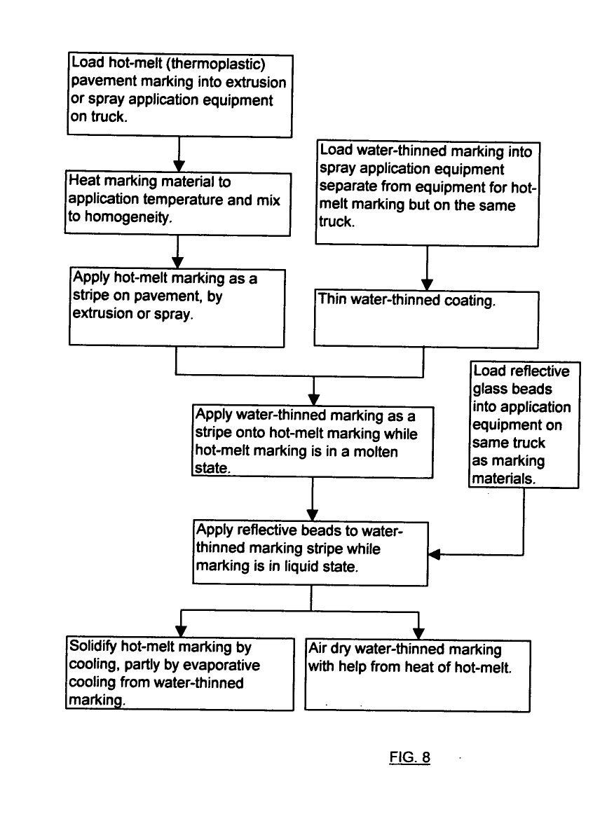

A still further example of the diverse potential of the coating system disclosed herein is pavement marking, most commonly road marking. The disclosed coating system can be applied as a finished marking system, to delineate lanes and otherwise mark existing pavement surfaces for visibility. In FIG. 8 is a flow-chart that illustrates the process of application of the disclosed coating system as pavement marking. For this application the hot-melt, or thermoplastic, marking can be manufactured by thorough dispersion of any fillers and pigments present, and the whole mixed to homogeneity, as for other applications. Alternatively, the ingredients can be mixed cold, to be melted and further mixed by the end user.

The hot-melt film is capable of application at a thickness sufficient to raise reflective beads incorporated into road markings above the surface of the water on rainy nights. This can significantly increase retroreflection from a reflectorized marking stripe and thus improve its night visibility. Other thermoplastic road markings offer the same advantage. But the water-thinned stripe that can be formed during application of the disclosed coating system provides at least four significant advantages over markings that are laid down in a single thermoplastic application. First, the cooling effect of the water-thinned stripe can prevent the tendency to slump and spread that often plagues thermoplastic stripes thicker than about four millimeters. Second, when white marking is applied to concrete, where lack of color contrast can impair visibility, contrast can be enhanced by incorporating black pigment into the thermoplastic stripe and laying a narrower white water-thinned stripe onto a wider thermoplastic stripe. This provides a more visible white stripe that contrasts with the black stripe on either side of it. This concept was disclosed by Britt, who used two thermoplastic markings of contrasting color, in U.S. Pat. No. 6,679,650 (2004). The third advantage is that the water-thinned marking can be designed for a slower rate of erosion by the weather than is normally expected of thermoplastic markings. Prevention of rapid weather erosion can delay the release of glass beads used to reflectorize the film. The fourth and final advantage is that the water-thinned stripe provides durable opacity and color so that expensive color pigmentation of the thermoplastic stripe can be unnecessary.

An important factor contributing to durability of the disclosed pavement marking system is that the coating that must adhere to the road surface is the hot-melt coating. Road surfaces are notorious for poor surface preparation before marking, and hot-melt coatings have a better record of adhering to them than do water-thinned coatings. In the coating system disclosed herein, the water-thinned coating is only required to adhere to the hot-melt coating surface; not to the pavement surface. The two-coat system is designed, as previously described, to facilitate wetting of the hot-melt coating surface by the water-thinned coating, and to promote intercoat adhesion. Furthermore, application to a hot-melt coating surface while it is still molten can help assure good water-thinned coating adhesion.

The drying of the water-thinned coating by heat from a source external to the coating system can be impractical when applying pavement marking. In this case, it can be necessary to include low concentrations of organic solvents in the water-thinned coating to soften the polymer particles and promote their coalescence into a continuous film. Inclusion of such solvents adds volatile organic compounds, restricted by environmental regulations, to the coating.

Yet a further example of the versatility of the disclosed coating system relates to protection of a wooden truck floor. One previously used method is lamination of a polyvinyl chloride sheet to the underside of the floor to prevent the transport of moisture from underneath the floor into the cargo space of the truck, and to protect against wear, and cracking of the wood. A thick coat of hot-melt coating overcoated with water-thinned paint to facilitate handling can provide a less expensive alternative. (cf. U.S. Pat. No. 6,601,357 (2003) to Tunis).

### ADVANTAGES

The reader will see that the processes of the various embodiments can be used for the near-simultaneous application of two altogether different but synergistic organic coatings. In the two-coat system that is formed, each coating works with the other to provide unique advantages in the protection and decoration of the surface or in the enhancement of its visibility. The various ways in which each of the coatings in the system disclosed herein functions to protect the other coatings in the system, the underlying substrate and subsequently applied coatings has been previously been described. The disclosed coating system will accept as a subsequent coat virtually any type of widely used field-applied architectural coating or coating component of an interior panel finishing system, and many types of finish for ferrous metal.

Although the disclosed coating system is, as has been pointed out, capable of protecting forest product based structural components from accidental damage and abuse, no coating can provide perfect protection of this kind under all circumstances. When damage does occur during erection of a structure, the coating has been shown to be readily repairable. Damaged areas can be sanded to eliminate any roughness incurred, and durably coated with conventional latex exterior primer and house paint.

The hot-melt coating can dry very rapidly and can provide tenacious adhesion and exceptional flexibility, extensibility, and impermeability to moisture. It can also minimize swelling by water of an underlying forest product based structural component. Because of the high durability of the disclosed coating system alone, as a factory-applied primer prior to finish coat application, painting schedules on architectural construction jobs can be far more flexible than is the case with currently used factory-applied primers.

Transmission of moisture from the inside of a structure, through the siding to the outdoors, must be efficient enough to avoid causing wet conditions within components of the structure. Otherwise the consequences can be structural decay or the growth of toxic mold. Moisture transmission through forest product siding material coated with the coating system disclosed herein, used as a primer, plus a conventional oil paint finish, has been shown to be comparable to transmission through the same siding coated with a conventional oil paint system. Such oil paint coating systems have of course been used for centuries without causing unwanted moisture condensation.

Materials and equipment employed in the manufacture and application of the coating system disclosed herein are commonly and readily available. The manufacturing processes and coatings application processes employed are well known to those skilled in the art. Industrial coating application lines can be short and can operate at desirable speeds. The necessary packaging processes to prepare the coatings for commercial distribution, and containers suitable for them, are in common use for other products. The coatings are stable under common warehouse storage conditions. Their manufacture and application is exceptionally free of fire hazard, and they can readily be formulated to be virtually free of volatile solvents that pollute the air and are often toxic.

An aspect of the utility of the disclosed coating system is its ability to be formulated for excellent durability in the weather. This characteristic includes superior performance compared with high quality conventional coatings appropriate to the particular surface, on forest product surfaces very difficult to successfully coat, such as “AC” grade smooth sanded plywood and southern yellow pine lumber. This was an unexpected performance property that became known only after years of exterior exposure testing. It therefore contributes novelty to the invention. High durability is very important to usefulness for pavement marking, where resistance to erosion translates into the ability to hold reflective glass beads for an extended period of time. Another characteristic unexpectedly observed during weathering tests, and adding novelty to the invention, is that barrier properties attributable to high film integrity enhance mildew resistance on forest product surfaces even without fungicidal additives.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

I claim:

1-19. (canceled)

20. A process, comprising:
(A) applying a first hot-melt organic coating to one or more manufactured solid surfaces at the point of manufacture of said solid surfaces;
wherein the solid surface comprises ferrous metal or a forest product based material; and
wherein the first hot-melt organic coating wets and adheres to said solid surface; and
wherein the first hot-melt organic coating comprises less than 5 percent by weight of volatile materials and is a solid at ambient temperature but liquefied at elevated temperatures; then
(B) applying a water-thinned organic protective coating to the first hot-melt organic coating;
wherein the water-thinned organic protective coating is not a bituminous coating;
wherein the water-thinned organic protective coating is applied while the first hot-melt organic coating is in a molten state;
wherein the water-thinned organic protective coating wets and adheres to the first hot-melt organic coating; then
(C) solidifying the first hot-melt organic coating by cooling; followed by or simultaneously
(D) drying the water-thinned organic protective coating by evaporation of volatile materials to form a dried film;
whereby a durable protective coating system can be provided;
wherein said durable protective coating system can be either a primer intended to be re-coated with a conventional finish, or alternatively can be a finish.

21. The process of claim 20, wherein heat is applied to dry the water-thinned organic protective coating.

22. The process of claim 20, wherein the first hot-melt organic coating forms chemical cross-links during step (D) or
wherein step (D) is followed by the formation of chemical cross-links in the first hot-melt organic coating.

23. The process of claim 22, wherein the water-thinned organic protective coating forms chemical cross links during step (D) or
wherein step (D) is followed by the formation of chemical cross-links in the water thinned organic protective coating.

24. The process of claim 22 wherein the first hot-melt organic coating comprises:
i. one or more vegetable drying oils, synthetic resins formed by chemical combination of vegetable oils with some or all of the group of chemical entities that includes polyols, polyfunctional carboxylic acids, rosin, polyfunctional isocyanates and glycidyl ethers, or a blend of one or more vegetable drying oils with one or more of the synthetic resins; and
ii. one or more metallic soap drier catalysts.

25. The process of claim 20, wherein the water-thinned organic protective coating comprises one or more latex emulsions, one or more pigments, and one or more particulate fillers;
wherein the water-thinned organic protective coating has a critical pigment volume concentration; and
wherein the proportion of the volume of the pigments and the fillers, in combination, to the total volume of non-volatile materials in the water-thinned organic protective coating, exceeds the critical pigment volume concentration;
wherein heat is applied to dry the water-thinned organic protective coating;
wherein the first hot-melt organic coating forms chemical cross-links during step (D) or
wherein step (D) is followed by the formation of chemical cross-links in the first hot melt organic coating; and
wherein the water-thinned organic protective coating forms chemical cross-links during step (D) or
wherein step (D) is followed by the formation of chemical cross-links in the water-thinned organic protective coating.

26. The process of claim 20, wherein the forest product-based material comprises wood or materials made from wood.

27. The process of claim 26, wherein the manufactured solid surface is a decorative interior surface; and
wherein the first hot-melt organic coating and the water-thinned organic protective coating together comprise a complete finishing system or, alternatively, comprise part of a multi-coat finishing system.

28. The process of claim 26, wherein the water-thinned organic protective coating comprises one or more latex emulsions, one or more pigments and one or more particulate fillers;
wherein the water-thinned organic protective coating has a critical pigment volume concentration; and
wherein the proportion of the volume of the pigments and the fillers, in combination, to the total volume of non-volatile materials in the water-thinned organic protective coating, exceeds the critical pigment volume concentration;
wherein heat is applied to dry the water-thinned organic protective coating;
wherein the first hot-melt organic coating forms chemical cross-links during step (D) or
wherein step (D) is followed by the formation of chemical cross-links in the first hot-melt organic coating; and
wherein the water-thinned organic protective coating forms chemical cross-links during step (D) or
wherein step (D) is followed by the formation of chemical cross-links in the water thinned organic protective coating.

29. The process of claim 20, wherein the manufactured solid surface comprises ferrous metal and
wherein the first hot-melt organic coating and the water-thinned organic protective coating comprise an anti-corrosive coating system.

30. The process of claim 20, further comprising applying a second hot-melt organic coating immediately after step (A);
wherein the second hot melt organic coating wets and adheres to the first hot-melt organic coating; and
wherein the water-thinned organic protective coating is applied to and wets and adheres to the second hot-melt organic coating.

31. A process, comprising:
(A) applying a first hot-melt organic coating to one or more manufactured solid surfaces at the point of manufacture of said solid surfaces;
wherein the solid surface comprises a ferrous metal or a forest product-based material, and
wherein the first hot-melt organic coating comprises less than five percent by weight of volatile materials and is a solid at ambient temperature but liquefied at elevated temperatures; and
wherein the first hot-melt organic coating comprises less than about 25 parts by weight of a hydrogenated block copolymer per 100 parts by weight of total polymer contained therein; then
(B) solidifying the first hot-melt organic coating by cooling; followed by
(C) applying a water-thinned organic protective coating to the first hot-melt organic coating;
wherein the water-thinned organic protective coating is applied while the first hot-melt organic coating is in a solid state;
wherein the water-thinned organic protective coating wets and adheres to the first hot-melt organic coating; then
(D) drying the water-thinned organic protective coating by evaporation of volatile materials to form a dried film;
whereby a durable protective coating system can be provided;
wherein said durable protective coating system can be either a primer intended to be re-coated with a conventional finish or, alternatively, can be a finish coat.

32. A process, comprising:
(A) applying a first hot-melt organic coating to one or more solid surfaces
wherein the solid surface comprises pavement and
wherein the first hot-melt organic coating wets and adheres to the solid surface; and
wherein the first hot-melt organic coating comprises less than 5 percent by weight of volatile materials and is a solid at ambient temperature but liquefied at elevated temperatures; then
(B) applying a water-thinned organic protective coating to the first hot-melt organic coating
wherein the water-thinned organic protective coating is sufficiently opaque to ultraviolet solar radiation to provide protection to the hot-melt organic coating for the expected life of the coating system;
wherein the water-thinned organic protective coating is not a bituminous coating;
wherein the water-thinned organic protective coating is applied while the first hot-melt organic coating is in a molten state;
wherein the water-thinned organic protective coating wets and adheres to the first hot-melt organic coating; then
(C) solidifying the first hot-melt organic coating by cooling; followed by or simultaneously
(D) drying the water-thinned organic protective coating by evaporation of volatile materials to form a dried film;
whereby a durable stripe for pavement marking can be provided;

33. A manufactured article coated at its point of manufacture with an organic coating system consisting essentially of two or three successive coats of coatings of different compositions;
wherein the manufactured article comprises ferrous metal or a forest product-based material;
wherein the first coat is a hot-melt organic coating; comprising less than about 25 parts by weight of a hydrogenated block copolymer per 100 parts by weight of total polymer contained therein;
wherein a subsequent coat, except the final coat, is a hot-melt organic coating comprising less than about 25 parts by weight of a hydrogenated block copolymer per 100 parts by weight of total polymer contained therein;
wherein a final coat is a water-thinned organic protective coating and
wherein the water-thinned organic protective coating is not a bituminous coating.

34. The manufactured article of claim 33, wherein the forest product-based material comprises wood or materials made from wood.

35. The manufactured article of claim 34, wherein the manufactured article is a decorative interior article.

36. The manufactured article of claim 33, wherein the manufactured article comprises ferrous metal and
wherein the organic coating system comprises an anti-corrosive coating system.

37. The manufactured article of claim 33, wherein one or more of the hot-melt organic coatings is chemically cross-linked.

38. The manufactured article of claim 33, wherein the number of the coatings of different compositions is two;
wherein the first coat is chemically cross-linked;
wherein the water-thinned organic protective coating comprises one or more latex emulsions, one or more pigments and one or more particulate fillers;
wherein the water-thinned organic protective coating has a critical pigment volume concentration;
wherein the proportion of the volume of the pigments and the fillers, in combination, to the total volume of non-volatile materials in the water-thinned organic protective coating, exceeds the critical pigment volume concentration; and
wherein the water-thinned organic protective coating is chemically cross-linked.

39. The manufactured article of claim 33, wherein the water-thinned organic protective coating is sufficiently opaque to ultraviolet solar radiation to provide protection to the hot-melt organic coating or coatings and to the solid surface, for the expected life of the coating system.
